(19) United States
(12) Patent Application Publication
(10) Pub. No.: US 2002/0083784 A1
(43) Pub. Date: Jul. 4, 2002

(54) Ball ramp actuator for locking mechanism

(75) Inventors: Michael C. Brauer, New Hartford, CT (US); Michael A. Ignaffo, Ypsilanti, MI (US)

Correspondence Address: Michael Best & Friendrich LLP, 3773 Corporate Parkway, Suite, 360, Center Valley, PA, 18034, US

(73) Assignee: The Torrington Company, Torrington, CT

(21) Appl. No.: 09/966,217

(22) Filed: Sep. 27, 2001

Related U.S. Application Data
(60) Provisional application No. 60/246,002, filed on Nov. 3, 2000.

(51) Int. Cl. F16H 25/12

(52) U.S. Cl. 74/57

(57) ABSTRACT

Two cam plates each have at least one groove providing a non-circumferential ball ramp. The ball ramp of the second cam plate intersects with the ball ramp of the first cam plate when viewed axially. At least one ball is positioned between the first and second cam plates, in the grooves of the first and second cam plates. The ball is biased radially to ensure that the ball follows the non-circumferential ball ramps of both cam plates in response to relative rotation of the two cam plates.

### BACKGROUND OF THE INVENTION

This invention relates generally to ball cams and, more particularly, to ball cams that are used as locking devices.

Ball ramps or ball cams with circumferentially directed ramped ball tracks are used for a variety of applications from brakes to transmissions. Such designs are illustrated, for example, in U.S. Pat. Nos. 6,082,504; 3,991,859; 5,528,950; and 5,910,061. FIGS. 1 and 2 illustrate a cam plate 10 with circumferential grooves 12 providing ramped ball tracks according to the prior art.

Compared to simple cam locks with sliding surfaces, the rolling contact provided by ball cam mechanisms reduces friction and operator effort while effecting a significantly greater clamping force. Some of these ball cam mechanisms are configured such that an actuating lever drives the rolling elements, thereby ensuring the position of each rolling element in relation to a known locked or unlocked lever position.

Ball cam mechanisms according to the prior art are not suitable for use as a lock mechanism for a steering column position adjustment. If such ramped ball track mechanisms were used in that application, the locking clamp loads would not be satisfactory because the balls would not track precisely enough to ensure that locking would occur every time every time the steering column position was adjusted, with no slipping.

The foregoing illustrates limitations known to exist in present devices and methods. Thus, it is apparent that it would be advantageous to provide an alternative directed to overcoming one or more of the limitations set forth above. Accordingly, a suitable alternative is provided including features more fully disclosed hereinafter.

### SUMMARY OF THE INVENTION

In one aspect of the invention, this is accomplished by providing a first cam plate having at least one groove providing a non-circumferential ball ramp and a second cam plate rotatable with respect to the first cam plate, and having at least one groove providing a non-circumferential ball ramp. The ball ramp of the second cam plate intersects with the ball ramp of the first cam plate when viewed axially. A ball is positioned between the first and second cam plates, in the grooves of the first and second cam plates. Biasing means biases the ball radially to ensure that the ball follows the non-circumferential ball ramps of both cam plates in response to relative rotation of the two cam plates.

The foregoing and other aspects will become apparent from the following detailed description of the invention when considered in conjunction with the accompanying drawing figures.

### BRIEF DESCRIPTION OF THE DRAWING FIGURES

FIG. 1 is a pictorial view of a cam plate illustrating a ball ramp actuator according to the prior art;

FIG. 2 is an axial view of the cam plate of FIG. 1;

FIG. 3 is an axial view of a ball ramp actuator, with internal ball tracks indicated by dotted lines, illustrating an embodiment of the present invention;

FIGS. 4-7 are axial views of various ball retainers that may be used with alternative embodiments of the present invention; and

FIG. 8 is an enlarged sectional view of the ball retainer of FIG. 5, as indicated by the line 8-8 of FIG. 5.

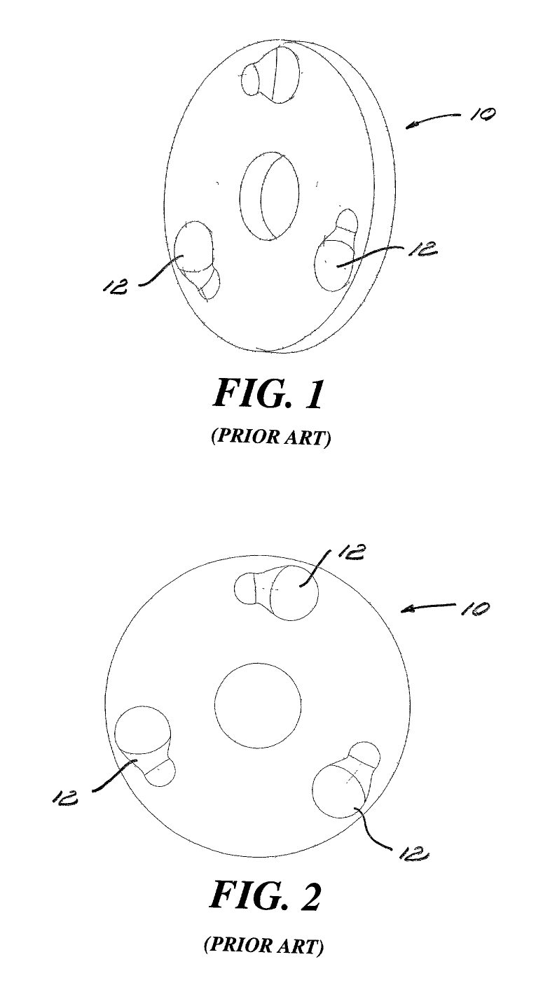

### DETAILED DESCRIPTION

One aspect of the present invention comprises a non-circumferential orientation of ball tracks of a ball ramp actuator. Conveniently, two identical plates may be used, facing each other, to achieve an intersecting configuration (when viewed axially) that defines a precise location of a ball during its movement up and/or down the ramps of the respective ball tracks. This reduces ball slippage with respect to each plate and increases the reliability of locking effected by the actuating mechanism.

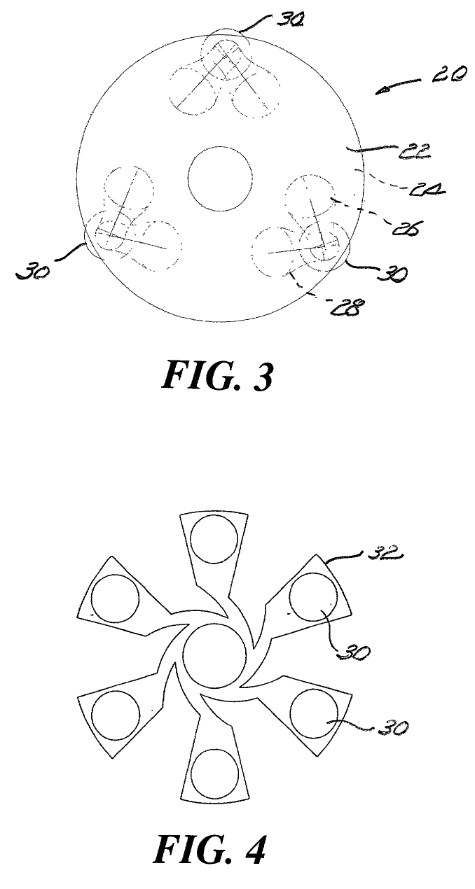

FIG. 3 is an axial view of a ball ramp actuator 20 comprising two identical cam plates 22 and 24 with non-circumferential ball tracks, comprising grooves 26 and 28, facing each other, with three balls 30 therebetween, illustrating the present invention. As the cam plates 22 and 24 are rotated with respect to each other, the balls 30 are driven radially, while staying in the intersecting opposed ball tracks, ensuring their precise location as they move up and down the ramps of the grooves 26 and 28, without slippage.

Ball ramp actuator 20 may be mounted on a steering column, for example, for spreading apart or squeezing together members to lock the steering column after adjustment of tilt or length. In such an application, one cam plate 22 may be fixed against rotation and the other cam plate 24 may be rotatable by a lever arm to allow an operator to effect locking and unlocking of position of the steering column. Other anticipated applications may be similar.

This design, using a non-concentric ball ramp path, imparts a radial motion (either radially inward or radially outward) to the balls 26 when the ball ramp actuator 20 is moved into the locked or unlocked position. When rotating a lever arm into a locked or unlocked position, the balls 30 move radially inward or radially outward, depending on the configuration of the ramps. The ramps may direct the balls 30 axially inward or outward, as the ball moves radially in response to movement of the lever arm.

Furthermore, the shape of the non-concentric ramps may be varied to change the performance of the actuator such that one can minimize effort at peak load, or to alter the locking versus unlocking engagement effort.

A preferred method of making the cam plates 22 and 24 suitable for the invention is to progressively form the ramp shapes from metal strip. An anti-rotation (or stop) feature may be formed in that way at the same time the ramp is formed. Other methods of manufacture of the cam plates may be by CNC machining directly from stock or by powdermetal forming. If required loads are sufficiently light, the cam plates 22 and 24 may be economically formed of a polymer by injection molding.

If one or more balls 30 remain in an unlocked position despite the remainder of the mechanism moving to a locked position, this non-engagement or partial engagement of the balls may result in unreliable clamp loads and excessive wear. The risk of this condition is greatest when a moment is applied to the lever of the actuating mechanism that urges the cam plates 22 and 24 into a non-parallel relationship.

To reduce or eliminate any risk of non-engagement or partial engagement of the balls, a spring-integrated retainer or other biasing means may be provided to apply a small biasing pre-load onto the balls to ensure that the balls stay in contact with the ramps during locking and unlocking. Ensuring this contact prevents the balls from remaining in an unlocked position when the mechanism is moved into a locked position.

FIGS. 4-7 illustrate possible ball retainers 32, 34, 36 and 38, respectively, that deform elastically to provide the biasing of the balls 30, as just described. Each ball retainer may be molded of nylon, or other suitable flexible polymer, or may be made of metal. These configurations may bias the balls 30 either radially outward or, alternatively, radially inward. As illustrated, the number of balls 30 may be increased to increase load capacity of the ball ramp actuator.

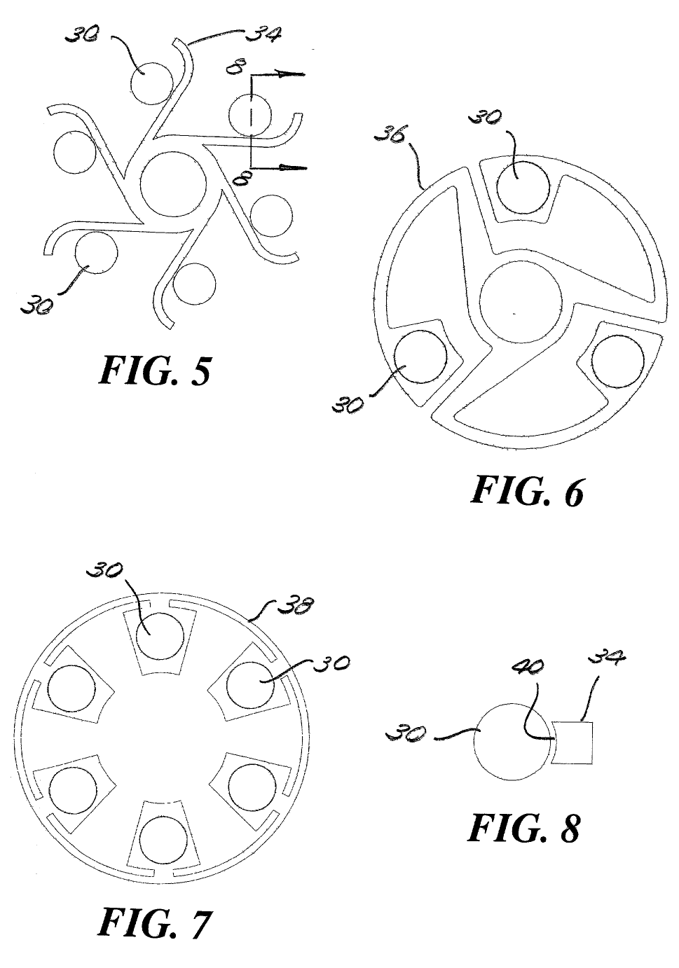

The ball retainers 32, 36 and 38 of FIGS. 4, 6 and 7, respectively, have round pockets for the balls 30. The ball retainer 34 of FIG. 5 has flexible arms that allow the balls 30 to ride up and down along the arms. The arms may overlap, as shown in FIG. 5, to reduce the risk of spring arm “set”. This configuration also maintains a relatively even spring force through all ball positions.

FIG. 8 illustrates that the arms of ball retainer 34 of FIG. 5 may have a concave surface in contact with the balls 30 to keep the arms centered with respect to the balls 30. This feature is particularly useful because the two cam plates 22 and 24 move axially apart and together to locked and unlocked positions, requiring a retainer that does not become wedged under the balls, thereby limiting their movement up or down the ball ramps.

Having described the invention, what is claimed is:

1. A ball ramp actuator for use as a locking mechanism, the actuator comprising:
a first cam plate having at least one groove providing a non-circumferential ball ramp;
a second cam plate rotatable with respect to the first cam plate, and having at least one groove providing a non-circumferential ball ramp, the ball ramp of the second cam plate intersecting with the ball ramp of the first cam plate when viewed axially;
a ball positioned between the first and second cam plates, in the grooves of the first and second cam plates; and
biasing means for biasing the ball radially to ensure that the ball follows the non-circumferential ball ramps of both cam plates in response to relative rotation of the two cam plates.

2. A ball ramp actuator according to claim 1, wherein the grooves become shallower as they extend radially outward such that radially outward movement of the ball spreads the cam plates apart.

3. A ball ramp actuator according to claim 1, wherein the biasing means comprises a ball retainer in contact with the ball and having resiliently deformable portions that serve as integral springs.

4. A ball ramp actuator according to claim 1, wherein the biasing means comprises a ball retainer with a pocket within which the ball is located.

5. A ball ramp actuator according to claim 1, wherein the biasing means comprises a ball retainer with a flexible arm in contact with the ball.

6. A ball ramp actuator according to claim 1, wherein the biasing menas comprises a ball retainer with a concave surface in contact with the ball such that the ball is centered with respect to the ball retainer.

7. A ball ramp actuator according to claim 1, wherein the biasing means comprises a ball retainer made of an elastically deformable polymer.

8. A ball ramp actuator according to claim 1, wherein the number of balls is three.

9. A ball ramp actuator according to claim 1, wherein the number of balls is more than three.

10. A ball ramp actuator according to claim 1, wherein the grooves include at least one spherical recess to provide a detent for maintaining the ball in a locked or unlocked position.
